(19) United States
(12) Patent Application Publication
(10) Pub. No.: US 2026/0297439 A1
(43) Pub. Date: Oct. 1, 2026

(54) BIO-OIL UPGRADING DISTRIBUTOR AND PROCESS

(71) Applicant: UOP LLC, Rosemont, IL (US)

(72) Inventors: Phuong T. M. Do, Mt. Prospect, IL (US); Azita Ahmadzadeh Dehghan, Naperville, IL (US); Mohammad-Reza Mostofi-Ashtiani, Naperville, IL (US); Christopher J. KETURAKIS, Arlington Heights, IL (US); Matthew J. Kline, Lombard, IL (US); Jennifer Ozmen, Wilmette, IL (US); Nickolas Kapaun, Chicago, IL (US); Ashim Mandal, Gurgaon (IN)

(21) Appl. No.: 19/633,987

(22) Filed: Mar. 30, 2026

Related U.S. Application Data
(60) Provisional application No. 63/781,931, filed on Apr. 1, 2025.

(51) Int. Cl. C10G 49/12; B01J 8/08

(52) U.S. Cl. CPC C10G 49/12; B01J 8/085; B01J 8/087; B01J 2208/00318; B01J 2208/00752; B01J 2208/00902; B01J 2208/00938; C10G 2300/1014

(57) ABSTRACT

A process for upgrading a bio-oil stream is disclosed. The process comprises charging a bio-oil stream at a temperature of about 95° C. or less through a feed distributor into a reactor. The feed distributor is cooled with a cooling fluid stream to maintain the temperature of the bio-oil stream. A hydrogen stream is passed to the reactor. The bio-oil stream is reacted with the hydrogen stream in the presence of a catalyst in the reactor to produce an upgraded bio-oil stream. The process avoids the polymerization of the bio-oil stream.

### FIELD

The field is related to a process for upgrading a bio-oil stream. Particularly, the field relates to a process for upgrading a bio-oil stream and a distributor for the same.

### BACKGROUND

Hydrocarbon conversion processes typically require reactor systems, and associated conduits and piping, adapted for hydrocracking, reforming, fluidized catalytic cracking, and other similar processes.

Bio-oils are obtained by thermochemical liquefaction, notably pyrolysis, such as flash, fast, slow or catalytic pyrolysis. Pyrolysis is a thermal decomposition process in the absence of oxygen with thermal cracking of the feedstocks to gas, liquid and solid products. A catalyst can be added to enhance the conversion in a so-called catalytic pyrolysis. Various technologies have been deployed for large scale biomass pyrolysis. They include bubbling fluidized beds, circulating fluidizing beds, ablative pyrolysis, vacuum pyrolysis, and rotating cone pyrolysis reactors. Catalytic pyrolysis generally leads to bio-oil having a lower oxygen content than bio-oil obtained by thermal decomposition. The selectivity between gas, liquid and solid is well related to the reaction temperature and vapor residence time. Lower temperature, for example, around 400° C. and longer residence time, for example, a few minutes to a few hours, obtained by slow pyrolysis, favors the production of solid product, also called char or char coal, with typically about 35 wt % gas, about 30 wt % liquid, and about 35 wt % char. Very high temperature of above about 800° C. used in the gasification processes favors gas production (typically more than about 85 wt %). Intermediate reaction temperature (typically about 450° C. to about 550° C.) and short vapor residence time (typically about 10 to about 20 s), for the so-called pyrolysis, favor the liquid yield: typically about 30 wt % gas, about 50 wt % liquid, and about 20 wt % char. Intermediate reaction temperature (typically about 450° C. to about 550° C.) and very short vapor residence time (typically about 1 to about 2 s) for the so-called flash pyrolysis or fast pyrolysis, favor even more the liquid yield: typically about 10 to about 20 wt % gas, about 60 to about 75 wt % liquid, about 10 to about 20 wt % char. The highest liquid yields may be obtained by the flash pyrolysis processes, with up to about 75 wt %.

Bio-oils can be processed to provide low-cost renewable liquid fuels; indeed, they can be used as fuel for boilers, as well as for stationary gas turbines and diesel engines. Furthermore, fast pyrolysis has been demonstrated at large scales, of the order of several hundred tons per day. Nevertheless, there has not been any significant commercial uptake of this technology. The reasons may relate mostly to the poor physical and chemical properties of bio-oils in general and fast pyrolysis bio-oils in particular. For example, some of the undesirable properties of pyrolysis bio-oils may include: (1) corrosivity on account of their high water and acidic contents; (2) relatively low specific calorific value on account of the high oxygen content, which typically is around 40% by mass; (3) chemical instability on account of the abundance of reactive functional groups like the carboxyl group and phenolic groups that can lead to polymerization on storage and consequent phase separation; (4) relatively high viscosity and susceptibility to phase separation under high shear conditions, for instance in a nozzle; (5) incompatibility with, on account of insolubility in, conventional hydrocarbon based fuels; (6) blockage in nozzles and pipes caused by adventitious char particles, which will always be present in unfiltered bio-oil to a greater or lesser degree. All these aspects combine to render bio-oil handling, shipping storage and usage difficult and expensive.

The economic viability of bio-oil production for fuel or energy applications therefore depends on finding appropriate methods to upgrade it to a higher quality liquid fuel at a sufficiently low cost.

Over the last two decades, the approach of direct hydroprocessing of bio-oil to convert it to stable oxygenates or hydrocarbons has been studied intensively. A major obstacle to the catalytic hydroprocessing of bio-oil has been its propensity to polymerize under heating above about 100° C., leading ultimately to the formation of extraneous solids or coke at temperatures above about 140° C., with consequences like reactor plugging and catalyst deactivation.

Therefore, there is a need for an improved process for bio-oil hydroprocessing that minimizes the formation of solids and catalyst deactivation and provides an upgraded deoxygenated oil product that can be used for producing useful fuels.

### SUMMARY

A process for upgrading a bio-oil stream is disclosed. The process comprises charging a bio-oil stream at a temperature of about 95° C. or less through a feed distributor into a reactor. The feed distributor is cooled with a cooling fluid stream to maintain the temperature of the bio-oil stream. A hydrogen stream is passed to the reactor. The bio-oil stream is reacted with the hydrogen stream in the presence of a catalyst in the reactor to produce an upgraded bio-oil stream.

A fuel oil stream can be taken from the upgraded bio-oil stream. The catalyst may be separated and recycled to the reactor. The upgraded bio-oil stream can be used directly to produce an intermediate blend or fuel. The process avoids the polymerization of the bio-oil stream by maintaining the temperature of the bio-oil stream before its entry into the reactor. The present process discloses cooling the bio-oil stream to a temperature of about 95° C. or less as it flows from the distributors into the reactor.

### BRIEF DESCRIPTION OF THE DRAWINGS

FIG. 1 illustrates a schematic diagram of the process for upgrading a bio-oil stream in accordance with an exemplary embodiment of the present disclosure.

FIG. 2 illustrates a schematic diagram of a portion of the schematic diagram of FIG. 1 showing an enlarged view of the feed distributor in greater detail in accordance with an exemplary embodiment the present disclosure.

FIG. 3 illustrates a schematic diagram of a portion of the schematic diagram of FIG. 1 showing an enlarged view of the feed distributor in greater detail in accordance with another exemplary embodiment the present disclosure.

FIG. 4 illustrates a schematic diagram of a portion of the schematic diagram of FIG. 1 showing an enlarged view of the feed distributor in greater detail in accordance with yet another exemplary embodiment the present disclosure.

FIG. 5 illustrates a schematic diagram of an alternate embodiment of the feed distributor as shown in FIG. 4 in accordance with yet another exemplary embodiment the present disclosure.

FIG. 6 illustrates a plot showing the bio-oil feed pump pressure (solid line) and the inlet temperature of the bio-oil entering the reactor (dashed line) for the Experiments A1-A3 in accordance with an exemplary embodiment of the present disclosure.

FIG. 7 illustrates a plot showing the bio-oil feed pump pressure (solid line) and the inlet temperature of the bio-oil entering the reactor (dashed line) for the Experiment B in accordance with an exemplary embodiment of the present disclosure.

### DEFINITIONS

As used herein the terms “reactor”, “process equipment,” “process units,” or “reactor components” shall include any and all process equipment and process units that are utilized in hydrocarbon conversion processes including any upstream and/or downstream equipment from the particular unit and/or ancillaries, such as furnace tubes, associated piping, heat exchangers, heater tubes, and the like.

As used herein, the term “predominant” or “predominate” or “predominance” means greater than about 50%, suitably greater than about 75% and preferably greater than about 90%.

As used herein, the term “carbon number” refers to the number of carbon atoms per hydrocarbon molecule and typically a paraffin molecule.

As used herein, “petroleum stream” or “petroleum feedstock” may refer to crude oil, crude oil refinery distillates, crude oil refinery residue, cracked products or hydrocarbons from a crude oil refinery, liquefied coal, bitumen, typically extracted from the ground or sea floor.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T10” or “T90” means the temperature at which 10 mass percent or 90 mass percent, as the case may be, respectively, of the sample boils using ASTM D-86 or TBP.

As used herein, the term “vacuum gas oil” (VGO) includes hydrocarbons having an initial boiling point above approximately 343° C. (650° F.), with a T10 boiling point temperature using ASTM D1160 of approximately 370° C. (698° F.) and a T90 boiling point temperature using ASTM D1160 of approximately 500° C. (932° F.).

As used herein, the term “stable oil” means an upgraded oil having the desired concentration of functional groups or properties that make it useful directly as a fuel or to produce an intermediate blend or fuel stream that can be transported or processed in a refinery process unit.

As used herein, the terms “mol % H” and “mol % C” refer to the percentage of moles of hydrogen or carbon atoms, respectively, of the total moles of hydrogen or carbon atoms in oil. For example, if the bio-oil composition contains 5 moles of hydrogen atoms and 10 moles of carbon atoms and it is said that the bio-oil contains 10 mol % H of aldehydes and 20 mol % C of carboxylic acids and esters it means that 0.5 moles of hydrogen atoms in the bio-oil correspond to H atoms of molecules with an aldehyde functional group and 2 moles of carbon atoms in the bio-oil correspond to C atoms of molecules with either a carboxylic acid or ester functional group.

As used herein, the term “bioderived” or “biogenic” material means a material that comes from or made of, but not limited to, plants, animals, microorganisms, algae, or biopolymers.

As used herein, the term “recycle ratio” or “recycle rate” means the ratio of the recycle flow rate to the fresh feed flow rate.

As used herein, the term “bio-oil” refers to any liquid organic material derived from biological or biomass sources, including but not limited to bio-oil, hydrothermal liquefaction oils, catalytically upgraded bio-oils, partially deoxygenated bio-oils, stabilized bio-oils, or any intermediates thereof.

### DETAILED DESCRIPTION

Polymerization during deoxygenation or hydrotreating reactions is a major challenge when attempting to convert bio-oils to fuels. The present disclosure provides a process to upgrade a biomass-based feed such as bio-oil to produce an upgraded bio-oil. The upgraded bio-oil can be used directly as fuel oil such as marine fuel. Alternatively, the upgraded bio-oil can be used as a feed stock for an FCC unit, a hydroprocessing unit, or a reforming unit to produce an intermediate blend or fuel. The present disclosure addresses the problem of bio-oil polymerization at higher temperatures.

Bio-oil perhaps is a complex mixture of compounds, including oxygenates, that are obtained from the breakdown of biopolymers in biomass. Bio-oils can be derived from plants such as grasses and trees, wood chips, chaff, grains, grasses, corn, corn husks, weeds, aquatic plants, hay and other sources of lignocellulosic material, such as derived from municipal waste, food processing wastes, forestry wastes and cuttings, energy crops, or agricultural and industrial wastes (such as sugar cane bagasse, oil palm wastes, sawdust, nut shells, or straws). Bio-oils can also be derived from pulp and paper products (recycled or not) or byproducts, such as black liquor, lignin, tall oil, tall oil pitch, or turpentine. Bio-oils are generally obtained from these biomass feeds by thermochemical liquefaction, notably pyrolysis, such as flash, fast, slow or catalytic pyrolysis. Hydrothermal liquefaction may also be utilized to generate bio-oil feeds. Several different processes which produce bio-oil can be utilized to produce biocrude feed. In an aspect, the bio-oil may be derived from lignocellulosic biomass.

Bio-oil is a highly oxygenated, polar hydrocarbon product that typically contains at least about 10 mass % oxygen, typically about 10 to about 60 mass % oxygen, more typically about 30 to about 50 mass % oxygen on a water-free basis. In general, bio-oil comprises oxygenates that may include alcohols, aldehydes, ketones, acetates, ethers, esters, organic acids and aromatic oxygenates. Oxygen is also present as free water which may constitute at least about 10 mass %, typically about 15 to about 35 mass % of the bio-oil. These properties render bio-oil immiscible with fuel grade hydrocarbons, even with aromatic hydrocarbons, which typically contain little or no oxygen or water.

In an aspect of the present disclosure, the biomass-based feed stream may comprise a bio-oil stream obtained by pyrolysis of a biomass feedstock.

In an exemplary embodiment, the biomass-based feed stream may comprise pyrolysis oil.

The biomass-based feed stream in the present disclosure may further contain other oxygenates derived from biomass such as vegetable oils or animal fat derived oils. Vegetable oil or animal fat-derived oil comprises fatty matter and therefore corresponds to a natural or elaborate substance of animal or vegetable origin, mainly containing triglycerides. This essentially involves oils from renewable resources such as fats and oils from vegetable and animal resources (such as lard, tallow, fowl fat, bone fat, fish oil and fat of dairy origin), as well as the compounds and the mixtures derived therefrom, such as fatty acids or fatty acid alkyl esters. The products resulting from recycling animal fat and of vegetable oils from the food processing industry can also be used, pure or in a mixture with other constituent classes described above. The feeds may comprise vegetable oils from oilseed such as rape, erucic rape, soybean, jatropha, sunflower, palm, copra, palm-nut, arachidic, olive, corn, cocoa butter, nut, linseed oil or oil from any other vegetable. These vegetable oils very predominantly consist of fatty acids in form of triglycerides (generally above about 97% by mass) having long alkyl chains ranging from 8 to 24 carbon number, such as butyric fatty acid, caproic, caprylic, capric, lauric, myristic, palmitic, palmitoleic, stearic, oleic, linoleic, linolenic, arachidic, gadoleic, eicosapentaenoic (EPA), behenic, erucic, docosahexaenoic (DHA) and lignoceric acids. The fatty acid salt, fatty acid alkyl ester and free fatty acid derivatives such as fatty alcohols that can be produced by hydrolysis, by fractionation or by transesterification, for example, of triglycerides or of mixtures of these oils and of their derivatives also come into the definition of the “oil of vegetable or animal origin” feed in the present disclosure. All products or mixtures of products resulting from the thermochemical conversion of algae or products from the hydrothermal conversion of lignocellulosic biomass or algae (in the presence of a catalyst or not) or pyrolytic lignin are also feeds that can be used.

Moreover, the feed containing bio-oil can be coprocessed with petroleum and/or coal derived hydrocarbon feedstocks. The petroleum derived hydrocarbon feed stock can be straight run vacuum distillates, vacuum distillates from a conversion process such as those from coking, from fixed bed hydroconversion or from ebullated bed or slurry hydrocracking heavy fraction hydrotreatment processes, or from solvent deasphalted oils. The feed can also be formed by mixing those various fractions in any proportions in particular deasphalted oil and vacuum distillate. They can also contain products from the fluid catalytic cracking units, such as light cycle oil (LCO) of various origins, heavy cycle oil (HCO) of various origins and any distillate fraction from fluid catalytic cracking generally having a T90 distillation range of about 150° C. to about 370° C. They may also contain aromatic extracts and paraffins obtained from the manufacture of lubricating oils. The coal derived hydrocarbon feedstock can be products from the liquefaction of coal. Aromatics fractions from coal pyrolysis or coal gasification can also be used as bio-mass based feed.

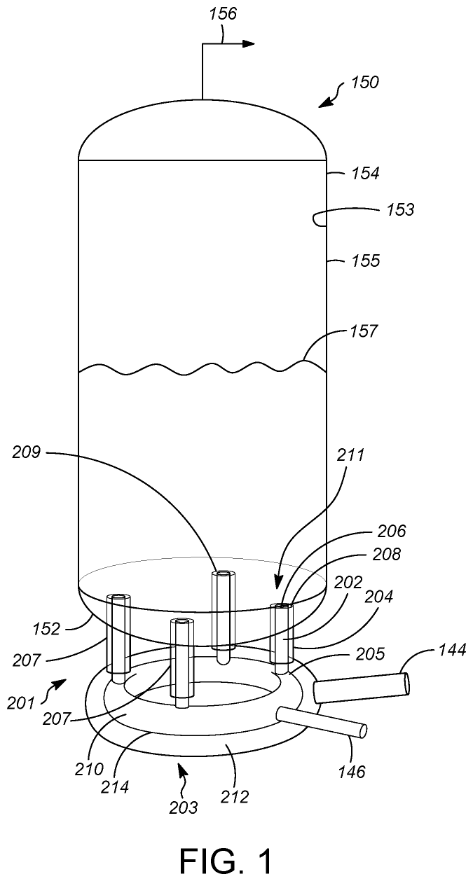

FIG. 1 shows an exemplary embodiment of the process for upgrading a bio-oil stream. A biomass-based feed stream is taken in feed line 146 from a source, for example, a storage drum. In an aspect, the biomass-based feed stream in feed line 146 may comprise bio-oil. In an exemplary embodiment, the biomass-based feed stream in feed line 146 may comprise a pyrolysis oil stream obtained by pyrolysis of a biomass feedstock. The bio-oil stream in feed line 146 may be taken from a mixer.

In an aspect, the bio-oil stream may be mixed with a non-bio derived feed stream in the mixer to provide a mixed feed stream which may be taken in the feed line 146. In an embodiment of the present disclosure, a petroleum stream is the non-bio derived feed stream. In an embodiment, a sulfur source comprising a sulfiding agent may be added to the petroleum stream or the bio-oil stream and passed to the mixer. In an aspect, the petroleum stream may be characterized as a stable oil stream having a desired concentration of the functional groups such as oxygenates.

In the mixer, the bio-oil stream and the petroleum stream may be mixed and kept well mixed at a predetermined ratio perhaps with an excess of the petroleum stream at the startup of the process. In an embodiment, the bio-oil stream and the petroleum stream may be mixed in the mixer at a mass ratio of the bio-oil stream and the petroleum stream of less than about 1 at the start-up to provide a mixed stream. After mixing, a mixed feed stream may be taken from the mixer in feed line 146. The mixed feed stream in feed line 146 may be charged to a reactor 150. In an aspect, the mixed stream in feed line 146 may comprise the bio-oil stream and the petroleum stream in a ratio of about 0:100 to about 80:20 by mass at start-up. In an exemplary embodiment, the petroleum stream may comprise vacuum gas oil (VGO). The mixed feed stream may be reacted with hydrogen in the presence of a catalyst in the reactor 150 to produce an upgraded bio-oil stream.

In another aspect, the bio-oil stream may be mixed with one or more recycle bio-oil upgrading product streams and recycled catalysts in the mixer. The bio-oil upgrading product streams may comprise one or more fuels streams produced from the bio-oil stream.

In an embodiment, the bio-oil stream in feed line 146 is charged to a liquid phase hydrotreating (LPH) reactor 150, for example, near a bottom of the reactor. A hydrogen stream may also be charged to the reactor 150 along with the bio-oil stream in feed line 146. In an embodiment, the hydrogen stream may be blended or mixed with the bio-oil stream in feed line 146 and charged to the reactor 150. A catalyst stream is also charged to the reactor 150. In an embodiment, the catalyst stream may be blended or mixed with the bio-oil stream to provide a charge stream. The charge stream may be taken in feed line 146 and charged to the reactor 150. In an aspect, a recycle oil stream may be combined with the bio-oil stream in the feed line 146. In the reactor 150, the petroleum stream, the bio-oil stream, the recycle stream, and the hydrogen stream may be reacted over a catalyst in a continuous liquid phase to provide an upgraded bio-oil stream. The upgraded bio-oil stream may be taken in line 156 from an outlet 112 in the shell 154 of the reactor 150. At least about 50 wt % of the upgraded bio-oil stream is bio-derived. Preferably, about 100 wt % of the upgraded bio-oil stream is bio-derived.

Liquid phase hydrotreating (LPH) is used for upgrading the heavy hydrocarbon feedstocks to produce distillate products. The hydrotreating catalyst typically comprises a solid particulate compound of a catalytically active metal, metal sulfide, or a metal in elemental form, either alone or supported on a refractory material such as an inorganic metal oxide (e.g., alumina, silica, titania, zirconia, and mixtures thereof). Other suitable refractory materials include carbon, coal, and clays. Zeolites and non-zeolitic molecular sieves are also useful as solid supports. One advantage of using a solid particulate either alone or supported is its ability to act as a “coke getter” or adsorbent of asphaltene precursors that have a tendency to foul process equipment upon precipitation.

Catalytically active metals for use in LPH include those from Group IVB, Group VB, Group VIB, Group VIIB, or Group VIII of the Periodic Table, which are incorporated in the heavy hydrocarbon feedstock in amounts effective for catalyzing desired hydrotreating reactions to provide, for example, lower boiling hydrocarbons that may be fractionated from the LPH effluent as naphtha and/or distillate products in the substantial absence of solid particulate. Representative metals include iron, nickel, molybdenum, vanadium, tungsten, cobalt, ruthenium, and mixtures thereof. The catalytically active metal may be present as a solid particulate in elemental form or as an organic compound or an inorganic compound such as a sulfide (e.g., iron sulfide) or other ionic compound. Metal or metal compound nanoaggregates may also be used to form the solid particulates.

In some embodiments, the metal compounds can be formed in situ, as solid particulates, from a catalyst precursor such as a metal sulfite (e.g., iron sulfite monohydrate) that decomposes or reacts in the LPH reaction zone environment, or in a pretreatment step, to form a desired, well-dispersed and catalytically active solid particulate (e.g., as iron sulfide). Catalyst precursors also include oil-soluble organometallic compounds containing the catalytically active metal of interest that thermally decompose to form the solid particulate (e.g., iron sulfide) having catalytic activity. Such compounds are generally highly dispersible in the heavy hydrocarbon feedstock and normally convert under pretreatment or LPH reaction conditions to the solid particulate that is contained in the slurry effluent. Catalyst precursors also include oil-soluble organometallic compounds, inorganic molybdenum compounds, or chelated metal compounds containing the catalytically active metal. Molybdenum chelates including molybdenum octoate, molybdenum dithiocarbamate, and molybdenum naphthenate and molybdenum compounds such as ammonium heptamolybdate and phosphomolybdic acid thermally decompose to form the solid particulate through reaction with sulfidation components in the feed or other sulfidation additives such as dimethyl disulfide, di-tert-butyl (poly) sulfide, dibenzyl disulfide, (di) allyl(di) sulfide, ammonium sulfite, dimethyl sulfite, dithiothreitol, elemental sulfur or thiourea to form, for example, molybdenum disulfide having catalytic activity. An exemplary in situ solid particulate preparation, involving pretreating, the heavy hydrocarbon feedstock and precursors of the ultimately desired metal compound, is described, for example, in U.S. Pat. No. 5,474,977.

In an aspect, a catalyst precursor with the sulfidation component or the sulfidation additive may be added to the petroleum stream and fed to the reactor 150 with the bio-oil stream in feed line 146. In another aspect, a catalyst or a catalyst precursor may be added to the bio-oil stream or the petroleum stream.

Alternatively, such metal sulfides or other active metal compounds can be formed ex-situ or in a separate process step through typical methods for producing metal sulfides. One such method includes hydrothermal synthesis where a molybdenum compound and sulfidation component are added to water with an additional reducing agent such as citric acid, oxalic acid, or hydrochloric acid or gaseous hydrogen. In some cases, the sulfidation component may also act as a reducing agent such as thiourea, ammonium sulfite, dimethyl sulfite, or dithiothreitol. The hydrothermal synthesis solution may be loaded into an autoclave reactor and sealed. If gaseous hydrogen is the reducing agent, the autoclave reactor can be pressurized from about 1378 kPag (200 psig) to about 10342 kPag (1500 psig) with hydrogen gas or the hydrogen gas can flow and bubble through the autoclave reactor. The autoclave reactor is then heated to a synthesis temperature of about 200° C. to about 300° C. under the foregoing hydrogen or inert gas pressure and held at the synthesis temperature for about 0.5 to about 16 hours. The autoclave reactor is allowed to cool to room temperature before depressurization and unloading. The solid catalyst can be collected such as by centrifugation, filtration, or drying. An example of hydrothermal metal sulfide synthesis is described in J. Espano, Phase Control in the Synthesis of Iron Sulfides, 145 J. Am. Chem. Soc. 18948-18955 (2023).

Another such method of forming metal sulfides ex situ could be a sulfiding procedure in a fixed bed reactor. Such methods involve loading a fixed bed reactor with a powdered or pelletized molybdenum compound and flowing a sulfiding gas, such as hydrogen sulfide, or a sulfiding liquid, such as oil doped with a sulfiding agent over the catalyst bed. The fixed bed reactor is heated to a sulfiding temperature of about 200° C. to about 350° C., for example, under the flow of sulfiding gas and/or hydrogen gas. The reactor is either pressurized before or after heating to sulfiding temperature to a pressure of about 1378 kPag (200 psig) to about 13790 kPag (2000 psig). The reactor may be heated slowly at, for example, 1° C./min and held at any temperature setpoints along the way to reach the final sulfiding temperature. The reactor may be held at temperature setpoints for hours to days. Once the sulfiding is complete, the reactor is cooled to room temperature and the catalyst is unloaded from the reactor in its metal sulfide form. The sulfided catalyst may be further reduced in particle size via grinding, milling, or other methods, so that the sulfided catalyst is a fine powder and highly dispersible.

Yet another method of forming metal sulfides ex situ could be a sulfiding procedure relying on chemical vapor deposition techniques. Such a method involves molybdenum compounds such as molybdenum trioxide, molybdenum dioxide, molybdenum foil, or dipotassium tetrathiomolybdate and sulfur compounds such as elemental sulfur, alkali sulfates, alkaline earth sulfates, or other metal sulfates or similar metal sulfites. A substrate is also used such as SiO₂/Si wafers, graphenes/graphites, or powdered or pelletized substrates commonly used as catalyst supports such as SiO₂, Al₂O₃, or TiO₂. Using a typical tube furnace synthesis reactor, the reactants and supports are placed in the reactor tube in a specific order with the sulfur source first (furthest upstream) followed by the molybdenum source downstream followed by the substrate further downstream. All compounds mentioned above are placed in a thermal zone in the tube furnace, typically in ceramic or other thermally and chemically resistant holders, which may be controlled as independent zones or as one zone. The substrate may be placed outside a thermal zone, if desired. This positioning is such that a gas flow through the tube first contacts the sulfur source, followed by the molybdenum source, followed by the substrate. A gas flow could include inert gas, hydrogen, steam, and/or oxygen/air. In typical operation, a gas flow is started and the tube furnace reactor zones are heated to a temperature that is suitable to vaporize one or more of the compounds mentioned above at ambient pressure, typically equal to or less than about 1000° C. The compounds vaporize and flow downstream where they react with each other and deposit on the substrate. The synthesis may run until complete consumption of all reactants or the substrate may be moved in and out of the apparatus so that the deposition time is limited to several minutes. After synthesis completion, the resulting metal sulfide is collected by removal of the substrate holder. The metal sulfide catalyst can be used as-is or, in the case of depositions of flat substrates like silicon wafers, the catalyst powder may be optionally scraped off for use without the silicon wafer. An example of chemical vapor deposition metal sulfide synthesis is described in W. Fu, Toward Edge Engineering of Two-Dimensional Layered Transition-Metal Dichalcogenides by Chemical Vapor Deposition,” 17 (17) ACS Nano 16348-16368 (2023).

Other suitable precursors include metal oxides that may be converted to catalytically active (or more catalytically active) compounds such as metal sulfides. In a particular embodiment, a metal oxide containing mineral may be used as a precursor of a solid particulate comprising the catalytically active metal (e.g., iron sulfide) on an inorganic refractory metal oxide support (e.g., alumina). Bauxite represents a particular precursor in which conversion of iron oxide crystals contained in this mineral provides an iron sulfide catalyst as a solid particulate, where the iron sulfide after conversion is supported on the alumina that is predominantly present in the bauxite precursor.

The active metals employed in the hydroprocessing catalysts of the present disclosure as hydrogenation components are the base metals of Group VIII, i.e., iron, cobalt, and nickel. In addition to these metals, other promoters may also be employed in conjunction therewith, including the metals of Group VIB, e.g., molybdenum and tungsten. The amount of hydrogenating metal in the catalyst can vary within wide ranges. Any amount between about 0.05 wt % and about 80 wt % may be used. In an aspect, molybdenum may be provided as a ground hydrotreating catalyst of particle size typically less than about 60 mesh, preferably less than about 100 mesh, more preferably less than about 200 mesh, and even more preferably less than about 400 mesh. The hydrotreating catalyst may be sulfided in situ or ex situ using any method mentioned throughout. In an aspect, molybdenum may be provided as an organic molybdenum such as molybdenum octoate or molybdenum dithiocarbamate which because it is oil or hydrocarbon soluble may be added directly to the hydrocarbon feed separately from or with the carbon particles. The molybdenum may react with sulfur provided in the hydrocarbon feed or an additive to produce molybdenum sulfide in the reactor which is the active form of the molybdenum catalyst.

Nickel may be provided as a catalyst in the way molybdenum is added.

In another aspect, the catalyst is a nickel and molybdenum sulfide catalyst where nickel is incorporated into the molybdenum sulfide molecular structure to enhance catalytic activity but may also form separate nickel sulfide phases with their own separate catalytic activity. In syntheses mentioned throughout that involve an aqueous solution, nickel can be added by simply introducing a nickel compound to the aqueous solution before heating to final synthesis temperature. In syntheses that involve a solid and gas or a solid and liquid method, nickel compounds may be physically mixed with the molybdenum compounds. For in situ formation of the nickel and molybdenum sulfide in the LPH, an oil-soluble nickel compound may be added directly to the feed or added from a separate line into the LPH. Nickel compounds that could be used include nickel octoate, nickel nitrate hexahydrate, nickel sulfate, nickel sulfite, nickel acetate tetrahydrate, nickel citrate hydrate, nickel hydroxide, or nickel hydroxide carbonate. The molar ratio of molybdenum to nickel can range from about 1:1 to about 5:1, preferably about 2:1 to about 4:1, or preferably about 2.5:1 to about 3.5:1.

The sulfur can be provided by a solid or liquid sulfiding agent that is added into the petroleum stream or added into a recycle stream to the reactor or premixed with the bio-oil stream. Gaseous sulfiding agents like hydrogen sulfide can be added to the hydrogen line 144. Some preferred sulfiding agents are hydrogen sulfide, dimethyl disulfide, di-tert-butyl(poly) sulfide, dibenzyl disulfide, (di) allyl(di) sulfide, ammonium sulfite, dimethyl sulfite, dithiothreitol, elemental sulfur or thiourea.

An aqueous molybdenum may be derived from reacting MoO₃ with an aqueous acid or basic solution such as phosphoric acid or ammonium hydroxide, respectively. Molybdenum in aqueous or oil-soluble liquid form in a volume selected to achieve target concentration may be dropped onto carbon particles which may serve as a carrier.

Without help from other catalysts, the concentration of the molybdenum in the liquid feeds to the LPH reactor may be more than 0 wppm and no more than about 2 wt % in the liquid feed, suitably no more than about 0.5 weight % in the liquid feed, and typically no more than about 2000 wppm in the liquid feed. In some cases, the concentration of molybdenum may be no less than 500 wppm in the liquid feed, and preferably not less than 1000 wppm of the feed.

In preferred embodiments where the catalyst contains both nickel and molybdenum, the concentration of the molybdenum in the liquid feed to the LPH reactor is the same as specified above. The concentration of the nickel in the liquid feed to the LPH reactor may be more than about 0 wppm and no more than about 2 wt % in the liquid feed, suitably no more than about 0.5 wt % in the liquid feed, and typically no more than about 2000 wppm in the liquid feed. In some cases, the concentration of nickel may be no less than about 500 wppm in the liquid feed, and preferably not less than about 1000 wppm of the feed. By feed, all feed streams to the reactor are meant.

In preferred embodiments a stream containing catalyst may be recycled to the reactor 150, perhaps in the feed line 146. Thus, the concentration of molybdenum in the reactor 150 can be controlled at a steady state greater than the concentration of molybdenum in the liquid feed. The concentration of elemental molybdenum in the reactor liquid is typically between about 0.1 wt % and about 10 wt %, preferably between about 0.5 wt % and about 7 wt % and more preferably between about 2 wt % and about 7 wt %, and even more preferably between about 0.2 wt % and about 3 wt %.

In a preferred embodiment, the charge stream in feed line 146 may comprise one or more of the bio-oil stream, the petroleum stream, and the catalyst stream. In an exemplary embodiment, the charge stream in feed line 146 may comprise bio-oil stream and a sulfided catalyst.

In accordance with the present disclosure, the charge stream comprising the bio-oil stream, and the catalyst in feed line 146 is charged into the reactor 150 at a predetermined temperature to avoid polymerization of the bio-oil. In an exemplary embodiment, the charge stream comprising the bio-oil stream, and the catalyst in feed line 146 may be charged to the reactor 150 at a temperature of about 95° C. or less, preferably at a temperature of about 80° C. or less, more preferably at a temperature of about 70° C. or less. The temperature of the charge stream should be at least about 25° C.

In accordance with the present disclosure, a distributor network 201 is shown in FIG. 1. The distributor network 201 comprises cooling the charge stream in the feed line 146 to maintain the bio-oil at a temperature of about 95° C. or less. The distributor network 201 may comprise a plurality of feed distributors 202 in communication with the feed line 146 for feeding the charge stream in feed line 146 into the reactor 150. Four feed distributors 202 are shown in FIG. 1, however there may be more or less than four feed distributors 202 for feeding the charge stream into the reactor 150. In an exemplary embodiment, the distributor network 201 may comprise a feed manifold 210 which may be a ring or tube in communication between the feed distributor 202 and the feed line 146. The feed manifold 210 may extend from the outer end 205 of the feed tube 207 of the feed distributor 202 and be in communication with the feed line 146. The feed manifold 210 may be in direct, downstream communication with the feed line 146. The feed manifold 210 may comprise a ring shape. The feed manifold 210 may be welded to the end of the feed line 146. This way the charge stream in the feed line 146 may enter the feed manifold 210 from the outlet of the feed line 146. The charge stream in feed line 146 may be supplied to one of the feed distributors 202 of the plurality of feed distributors from the feed manifold 210. In an aspect, the feed distributor 202 may be in direct communication with the feed manifold 210.

Each feed distributor 202 may comprise a feed tube 207. The outer end 205 of the feed tube 207 may be connected to the feed manifold 210, for example, by welding the outer end 205 of the feed tube 207 onto the feed manifold 210. This way the charge stream in the feed line 146 may be fed to the feed distributor 202 from the feed manifold 210. The feed tube 207 may be in downstream communication with the feed line 146 for transporting the bio-oil into the reactor 150.

FIG. 1 shows the distributor network 201 near a bottom 152 of the reactor 150. The distributors 202 are shown perpendicular to a tangent of bottom of the reactor 150. However, the distributors 202 may be provided at a suitable angle to the bottom of the reactor 150. In an aspect, the distributors 202 may be provided in the bottom of the reactor 150, suitably in the bottom half of the reactor. In another aspect, the one or more distributors 202 of the distributor network 201 may be provided in the top half of the reactor 150.

The reactor 150 may comprise a shell 154 having an inner surface 153 and an outer surface 155. The feed opening 206 of the feed tube 207 may be located inside the reactor 150 at a suitable location spaced inwardly from the shell 154 of the reactor 150. One feed distributor 202 of the plurality of feed distributors may comprise a feed opening 206 for feeding the charge stream in feed line 146 into the reactor 150. In an embodiment, the feed opening 206 of the feed tube 207 is disposed in a bottom half of the reactor 150 at an inner end 211 of the feed tube 207. Although, one feed opening 206 is shown in FIG. 1, the feed distributor 202 may comprise more than one opening for discharging the feed stream in the reactor 150 in a particular spray pattern.

A hydrogen gas stream may be fed to the reactor 150 with the charge stream in line 146. In an aspect, the hydrogen gas stream may be combined with the bio-oil stream and the catalyst and fed to the reactor 150 in a charge stream in line 146. In an embodiment, the hydrogen gas stream may be charged to the reactor 150 in a separate hydrogen line 144.

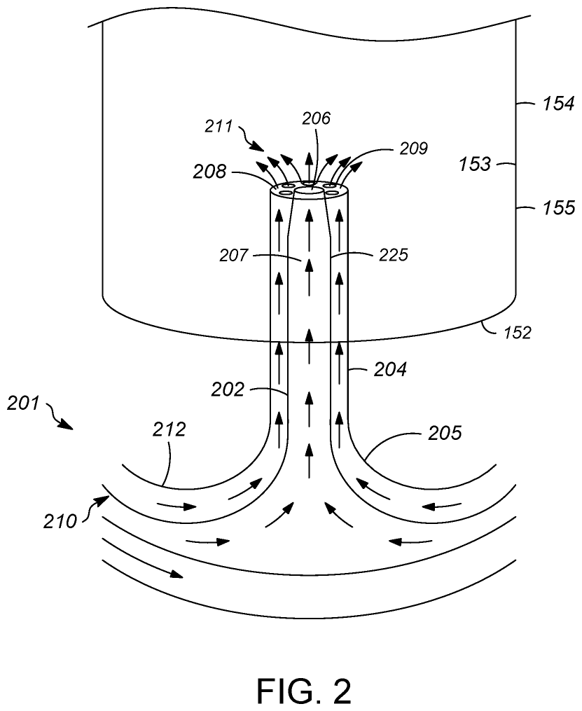

Bio-oil tends to polymerize at temperatures hotter than about 80° C. This causes plugging in the feed line and the reactor. The present disclosure addresses the problem of polymerization of the bio-oil at high temperature and the plugging caused by the polymerization of the bio-oil. The present disclosure provides cooling and maintaining the bio-oil stream at a temperature of no more than about 95° C., preferably at a temperature of about 80° C. or less, more preferably at a temperature of about 70° C. or less in the feed line 146 and the feed distributor 202. The bio-oil stream is cooled and maintained at a temperature of no more than about 95° C., preferably at a temperature of about 80° C. or less, more preferably at a temperature of about 70° C. or less up to the discharge of the charge stream from the feed opening 206 of the feed tube 207 into the reactor 150. Cooling and maintaining the bio-oil stream at the temperature of no more than about 95° C. from the feed line 146 to the feed opening 206 of the feed tube 207 provides a consistent flow of the charge stream through the feed line 146 and the feed distributors 202 of the distributor network 201 devoid of plugging. The consistent flow of the charge stream in the feed line 146, distributor network 201 and feed distributors 202 provides no dead volumes in the flow path inside the feed line 146, distributor network 201 and distributors 202. The present disclosure provides a distributor network 201 as shown in FIG. 2 with a provision for cooling the feed in the distributor 202 up to the point of discharging the feed from the feed opening 206 into the reactor 150 at a temperature of no more than about 95° C.

In accordance with the present disclosure, the distributor network 201 may comprise a cooling channel 203 adjacent to the feed manifold 210 extending through the shell 154 to the feed opening 206 of the feed tube 207 for maintaining the temperature of the feed distributor and the bio-oil stream by heat exchange with a cooling fluid stream. In an aspect, the cooling channel 203 is provided surrounding the plurality of feed tubes 207 to exchange heat and cool the charge stream flowing through the plurality of feed distributors 202 up to discharge of the charge stream into the reactor 150. The cooling channel 203 may also surround the feed manifold 210 to cool the charge stream flowing inside the feed manifold 210 and further cool the charge stream flowing through the feed distributors 202. In an exemplary embodiment, the cooling channel 203 may comprise a cooling manifold 212 surrounding the feed manifold 210 and a distributor cooling channel 204 surrounding one, some or all of the feed tubes 207 of the plurality of feed distributors 202. In an aspect, a distributor cooling channel 204 surrounds each of the feed tubes 207 of the plurality of feed distributors 202. The distributor cooling channel 204 may be adjacent to the feed tube 207 extending through the shell 154 to the feed opening 206 of the feed tube 207 for maintaining the temperature of the feed distributor 202 and the bio-oil stream by heat exchange with a cooling fluid stream. In an exemplary embodiment, the distributor 202 may comprise the feed tube 207 and the distributor cooling channel 204. In the exemplary embodiment as shown in FIG. 1, the distributor 202 comprising the feed tube 207 and the distributor cooling channel 204 may extend from the outer end 205 to the inner end 211 of the feed tube 207.

The cooling manifold 212 may be a ring and be in the shape of donut. The distributor cooling channel 204 may be attached to the cooling manifold 212, for example, by welding the distributor cooling channel 204 at the outer end 205 onto the cooling manifold 212. The distributor cooling channel 204 in direct downstream communication with cooling manifold 212, so that the cooling fluid from the cooling manifold 212 flows directly into the distributor cooling channel 204. The cooling channel 203 provides a continuous cooling of the feed inside the feed manifold because the cooling manifold 212 completely surrounds the feed manifold 210 and the feed inside the feed tubes 207 of the plurality of feed distributors 202 because the distributor cooling channel 204 completely surrounds the feed tubes 207 up to the feed opening 206 inside the reactor 150 from which the feed is discharged into the reactor.

The bio-oil stream may be cooled as it passes from the feed line 146 through the shell 154 of the reactor 150 and travels through the opening 206 in the distributor 202 into the reactor 150.

In an aspect, the cooling channel 203 may cool the charge stream in line 146 to a temperature of about 95° C. or less, preferably to a temperature of about 80° C. or less, more preferably to a temperature of about 70° C. or less up to the discharge of the charge stream from the feed opening 206 into the reactor 150.

As shown, the cooling channel 203 is in communication with a cooling fluid line 144. A cooling fluid stream may be passed from the cooling fluid line 144 into the cooling manifold 212, flow through the cooling manifold 212 and thereafter to the distributor cooling channel 204 to provide a cooled charge stream at a temperature of about 95° C. or less just before the discharge of the charge stream from the feed opening 206 into the reactor 150. The cooling manifold 212 and the feed manifold 210 share a wall through which heat is exchanged for cooling the feed stream flowing inside the feed manifold 210. In other words, an outer wall 214 of the feed manifold 210 may be an inner wall of the cooling manifold 212. The cooling manifold 212 may surround the outer wall 214 of the feed manifold 210 to provide an annulus with the cooling fluid stream cooling the charge stream flowing inside the feed manifold 210. In an embodiment, the cooling fluid stream in the cooling manifold 212 may cool the charge stream flowing inside the feed manifold 210 to a temperature of about 95° C. or less. A cooled charge stream then flows to the feed distributor 202 from the feed manifold 210. A heat exchanged cooling fluid stream from the cooling manifold 212 flows to the distributor cooling channel 204 to continue cooling the charge stream as the charge stream flows through the feed tube 207 up to discharge of the charge stream from the feed opening 206 into the reactor 150. In an exemplary embodiment, the cooling fluid line 144 may be a hydrogen gas line and the cooling fluid may be hydrogen gas.

The distributor cooling channel 204 and the feed tube 207 may share a wall through which heat is exchanged for cooling the first cooled charge stream flowing inside the feed tube 207. The distributor cooling channel 204 may surround the outer wall of the feed tube 207 to provide an annulus with the heat exchanged cooling fluid stream providing further cooling to the first cooled charge stream flowing through the feed distributor 202. In an embodiment, the heat exchanged cooling fluid stream in the distributor cooling channel 204 may continue to maintain the charge stream flowing through the feed tube 207 at a temperature of about 95° C. or less, preferably to a temperature of about 70° C. or less.

A first cooled charge stream flows to the feed distributor 202 from the feed manifold 210 after heat exchange with the cooling fluid stream in the cooling manifold 212. A heat exchanged cooling fluid stream from the cooling manifold 212 flows to the distributor cooling channel 204 to continue cooling the first cooled charge stream while flowing inside the feed distributor 202 up to discharge of the charge stream from the feed opening 206 into the reactor 150.

After heat exchange, a cooled charge stream is discharged from the feed opening 206 of the feed tube 207 into the reactor 150. The cooled charge stream may be at a temperature of about 95° C. or less, preferably at a temperature of about 70° C. or less at the feed opening 206 of the feed tube 207. The distributor cooling channel 204 may comprise a coolant opening 209 located inside the reactor 150 adjacent to the feed opening 206 in the feed distributor 202. In an embodiment, the coolant opening 209 is a second opening of the feed distributor 202 for discharging the cooling fluid stream into the reactor. In an alternate embodiment, the distributor cooling channel 204 is devoid of openings to prevent discharging the cooling fluid stream into the reactor 150. In an aspect, the distributor cooling channel 204 may communicate with a plurality of coolant openings 209 that may be concentric with the feed opening 206 in the feed distributor 202. The feed opening 206 and the coolant opening 209 may be spaced inwardly from the shell 154 of the reactor 150. In an embodiment, a heated cooling fluid stream may be discharged from the coolant opening 209 from the distributor cooling channel 204 into the reactor 150. The heated cooling fluid stream may be discharged from the coolant opening 209 into the reactor with the cooled bio-oil stream through the opening 206 of the feed tube 207. Although one opening 209 is shown in FIG. 1, the distributor cooling channel 204 may comprise more than one opening. Similarly, the feed distributor 202 may comprise more than one feed opening 206 at the inner end 211 in the reactor 150.

In an aspect, the cooling fluid stream may comprise a cooling gas. In an exemplary embodiment, the cooling fluid stream may comprise the hydrogen gas stream in the cooling fluid line 144 for cooling the charge stream in line 146. In such an embodiment, the cooling fluid line 144 is a hydrogen gas line. In another embodiment, the cooling fluid stream may comprise a recycled product or a diluent, for example, ethanol. In an exemplary embodiment, the cooling fluid stream may comprise a recycle gas stream. In another exemplary embodiment, the cooling fluid stream may comprise liquid petroleum gas.

Conditions in the LPH reactor 150 generally include a temperature from about 315° C. (600° F.) to about 538° C. (1000° F.), or about 321° C. (610° F.) to about 482° C. (900° F.), or about 340° C. (644° F.) to about 470° C. (878° F.), a pressure from about 3.5 MPa (500 psig) to about 30 MPa (4351 psig), suitably 5.5 MPa (800 psig) to about 19.3 MPa (2800 psig), preferably 6.8 MPa (1000 psig) to about 13.8 MPa (2000 psig), or more preferably no more than about 10.3 MPa (1500 psig), and a reactor liquid residence time from about 0.1 to about 8 hrs, preferably 2 to about 6 hrs, or 1 to about 5 hrs, or no less than about 3 hrs.

In another exemplary embodiment of the present disclosure, the reactor 150 may be a continuous stirred tank reactor (CSTR). Operating conditions in the CSTR 150 may be as given above but may preferably include a temperature from about 300° C. (572° F.) to about 500° C. (932° F.), a pressure from about 6.8 MPa (1000 psig) to about 13.8 MPa (2000 psig), and a residence time of about 30 mins. to about 8 hours. From the reactor 150, the upgraded bio-oil stream is taken in product line 156 extending from the shell 154. In an aspect, the product line 156 may be taken below the liquid level 157.

In an aspect, the reactor 150 may be selected from a bubble column reactor, a slurry reactor, and an ebullated bed reactor to facilitate contact and mixing of gases with liquid or slurry materials. Other types of reactors may be used to facilitate contact and mixing.

In another aspect, the reactor 150 may be a once-through reactor for processing the charge stream to produce the upgraded bio-oil stream.

In an embodiment, the upgraded bio-oil stream in line 156 may be passed to a separation section comprising one or more of a hot separator, a cold separator, and fractionation column. The upgraded bio-oil stream in line 156 may be passed to a hot separator where heavy oil is separated from the light oil. A hot bottoms stream comprising a stable oil may be taken from the bottom of the hot separator. The hot bottoms stream may comprise a majority of the catalyst, for example all the catalyst exiting from the reactor 150 may be taken in the hot bottoms stream. Light oil may be taken in a hot overhead stream from the hot separator. Water may also be separated in the hot separator which is taken with the light oil in the hot overhead stream. The hot separator may be run at a temperature of about 250° C. to about 400° C. and at a pressure of about the pressure of the reactor 150. A recycle oil stream comprising a stable oil and the catalyst may be taken from the hot bottom stream A solid or liquid sulfiding agent may be added to the recycle oil stream before recycling to the reactor 150. In an embodiment, the recycle oil stream may be combined with the bio-oil stream and the catalyst to provide the charge stream and taken in the feed line 146. The bio-oil stream, the catalyst, and the recycle oil stream may be charged to the reactor in the feed line 146.

In some embodiments, the presence of catalyst within the injection system may also provide a stabilizing effect on the bio-oil feed as it is introduced into elevated temperature regions of the reactor inlet. Without being bound by theory, it is believed that the catalyst can suppress or mitigate polymerization, condensation, or fouling reactions that might otherwise occur as oxygenated or reactive species in the bio-oil are exposed to heat prior to full conversion. This stabilizing effect may reduce the formation of deposits or plugs in the feed inlet or adjacent hot zones of the reactor inlet. In certain embodiments, the presence of catalyst may therefore permit operation at higher feed injection or reactor inlet temperatures than would be achievable in the absence of catalyst, while maintaining acceptable operability and flow characteristics.

The hot overhead stream comprising the light oil may be cooled and charged to a cold separator to separate gaseous components from the light oil. Water may be separated and taken from the boot of the cold separator. A light oil stream comprising the upgraded bio-oil stream may be taken from the bottom of the cold separator. The cold separator may be operated at a temperature of about 0 to about 75° C. and at a pressure of about the pressure of the reactor 150.

In an exemplary embodiment, the light oil stream comprising the upgraded bio-oil stream may be passed to the FCC unit to provide a FCC product stream. In another exemplary embodiment, the light oil stream comprising the upgraded bio-oil stream may be passed to a hydroprocessing unit to provide a hydroprocessing unit product stream. In yet another exemplary embodiment, the light oil stream comprising the upgraded bio-oil stream may be passed to a reforming unit to produce a reformed product stream.

In a preferred embodiment, the light upgraded bio-oil stream may be fractionated in a fractionation column to separate the light upgraded bio-oil stream into one or more hydrocarbon streams. The light upgraded bio-oil stream may be fractionated in the fractionation column to provide an overhead naphtha stream. A kerosene stream may be taken from a side of the fractionation column. From the bottoms of the fractionation column, a diesel stream may be taken. The fractionation column may be operated at vacuum pressure. In an embodiment, fractionation column may be operated at an overhead pressure of about 34 kPa (gauge) (5 psig) to about 173 kPa (gauge) (25 psig), and a bottoms temperature of about 500° C. (932° F.) to about 750° C. (1382° F.) or about 500° C. (932° F.) to about 600° C. (1112° F.).

FIG. 2 shows an enlarged view of the feed distributor 202 of the distributor network 201 as shown in FIG. 1. In an exemplary embodiment, the feed distributor 202 may comprise a feed tube 207 tapered at an inner end 211 with the feed opening 206 inside the reactor 150. For ease of explanation, one feed distributor 202 with a portion of the feed manifold 210 and the cooling manifold 212 are shown in FIG. 2. Coolant openings 209 are also visible in FIG. 2. The coolant opening 209 is an opening of the cooling channel 203 adjacent to the opening 206 of the feed tube 207 for discharging the cooling fluid stream into the reactor 150.

The distributor cooling channel 204 is disposed adjacent to an outer wall 225 of the feed tube 207. The cooling stream enters the distributor cooling channel 204 from the cooling manifold 212. Once the cooling stream exits the cooling manifold 212, the cooling fluid stream flows through the distributor cooling channel 204, in contact with the outer wall 225 of the feed tube 207 and cools the charge stream flowing through the feed tube 207. In an embodiment shown in FIG. 2, the distributor cooling channel 204 should extend up to the feed opening 206 of the feed tube 207 at the inner end 211 completely surrounding the outer wall 225 of the feed tube 207 into the reactor 150, where the cooling fluid stream then enters the reactor 150 through the feed opening 206. In an exemplary embodiment, the outer wall 225 of the feed tube 207 may comprise dimpled surface, such as, a plurality of concavities, for enhanced heat transfer.

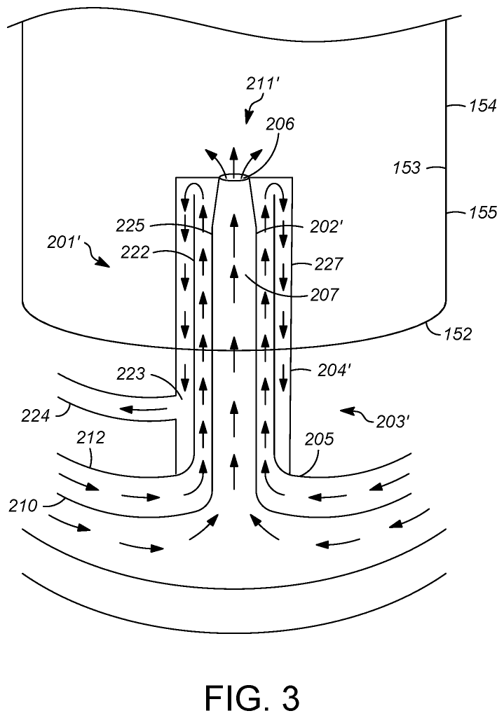

FIG. 3 shows another exemplary embodiment of the distributor network 201′. Elements in FIG. 3 with the same configuration as in FIG. 2 will have the same reference numeral as in FIG. 2. Elements in FIG. 3 which have a different configuration as the corresponding element in FIG. 2 will have the same reference numeral but designated with a prime symbol (′). The configuration and operation of the embodiment of FIG. 3 is essentially the same as in FIG. 1 with the following exceptions.

In the embodiment as shown in FIG. 3, only the feed opening 206 of the feed tube 207 may be located inside the reactor 150. As shown, the distributor cooling channel 204′ is devoid of an opening inside the reactor 150. The distributor cooling channel 204′ at the inner end 211′ is closed and spaced inwardly from the bottom 152 of the shell 154. So, the cooling fluid stream after heat exchange with the charge stream is not discharged into the reactor along with the cooled charge stream. In the embodiment as shown in FIG. 3, an discharge channel 224 is provided to transport the heated cooling fluid stream from the distributor cooling channel 204′ away from the inner end 211 of the distributor 202′. The exit channel 227 may take the form of an annulus around the cooling channel 204′ adjacent to the distributor cooling channel 204′.

For ease of explanation, the exit channel 227 in downstream communication with the distributor cooling channel 204′ is shown in FIG. 3. In an exemplary embodiment, a partition 222 may separate the distributor cooling channel 204′ from the exit channel 227. The partition 222 may be an open cylinder. The distributor cooling channel 204′ is disposed adjacent to an outer wall 225 of the feed tube 207. The exit channel 227 is spaced from the outer wall 225 of the feed tube 207 on an opposite side of the distributor cooling channel 204′. The partition 222 may serve as an outer wall of the distributor cooling channel 204′ and the inner wall of the exit channel 227.

The cooling stream enters the distributor cooling channel 204′ from the cooling manifold 212. Once the cooling stream exits the cooling manifold 212, the cooling fluid stream flows through the distributor cooling channel 204′, in contact with the outer wall 225 of the feed tube 207 and cools the charge stream flowing through the feed tube 207. In an embodiment shown in FIG. 3, the distributor cooling channel 204′ should completely surround the outer wall 225 of the feed tube 207 up into the reactor 150 extending to the feed opening 206 of the feed tube 207, where the cooling fluid stream then reverses and enters the exit channel 227. The heated cooling fluid stream is then conveyed through the exit channel 227 and out of the exit channel 227 of the cooling channel 203′ through a coolant outlet 223. The heated cooling fluid stream is discharged from the coolant outlet 223 into an exit manifold 224. The exit manifold 224 may be in the shape of a ring and be fed by all of the exit channels 227. The exit manifold 224 may transport the heated cooling fluid stream away from the distributor network 201. The exit manifold 224 may be a ring that surrounds the coolant manifold 212 and shares a wall therewith or be spaced from the coolant manifold. The heated cooling fluid stream may be cooled and recycled to the reactor 150.

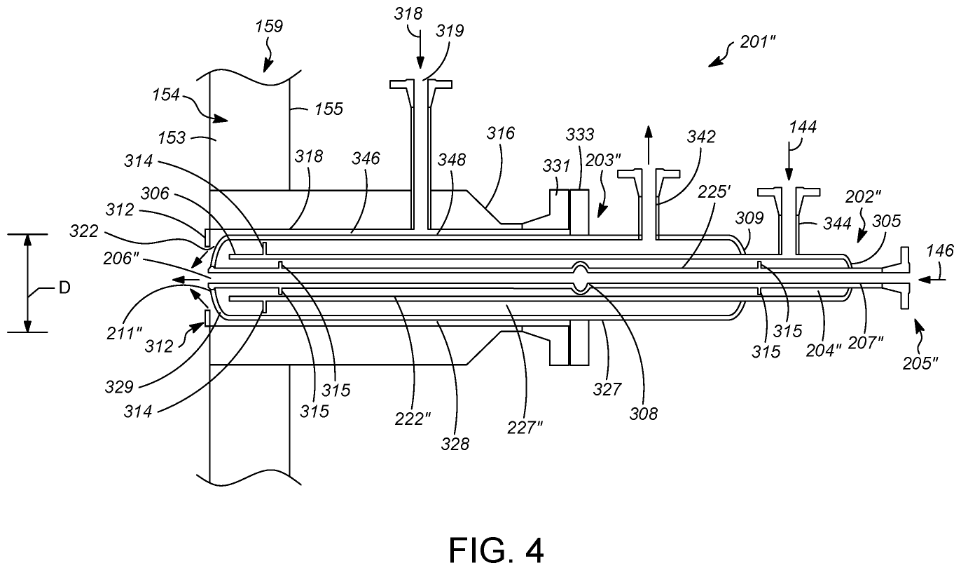

FIG. 4 shows an enlarged view of an additional embodiment of a feed distributor 202″ of a distributor network 201″. Elements in FIG. 4 with the same configuration as in FIG. 3 will have the same reference numeral as in FIG. 3. Elements in FIG. 4 which have a different configuration as the corresponding element in FIG. 3 will have the same reference numeral but designated with a double prime symbol (″). The configuration and operation of the embodiment of FIG. 4 is essentially the same as in FIG. 3 with the following exceptions.

In the embodiment as shown in FIG. 4, the reactor 150 may comprise a reactor nozzle 316 extending from the shell 154 of the reactor 150 for inserting the feed distributor 202″ in the reactor. For ease of explanation, only one reactor nozzle 316 is shown in FIG. 4. However, the reactor 150 may comprise more than one reactor nozzle 316 for inserting more than one feed distributor 202″ in the reactor 150. The feed distributor 202″ may be inserted or installed concentrically in the reactor nozzle 316. A securing element 333, such as a bolted flange, may be provided at the receiving end 331 of the reactor nozzle 316 for holding the feed distributor 202″ in the concentric position in the reactor nozzle 316 when installed. In an exemplary embodiment, the feed distributor 202″ may be installed in a shell 154 of the reactor 150 in the bottom half of the reactor 150. Alternatively, the feed distributor 202″ may be installed near the bottom of the reactor 150. In another alternate embodiment, the feed distributor 202″ may be installed on a side 159 of the reactor 150.

The feed distributor 202″ may be installed with some clearance from an inner wall 318 of the reactor nozzle 316. When the feed distributor 202″ is installed, the clearance between an outer wall 328 of the feed distributor 202″ and the inner wall 318 of the reactor nozzles 316 may define an annular space 346. In an aspect, the annular space 346 between the outer wall 328 of the feed distributor 202″ and the inner wall 318 of the reactor nozzle 316 may comprise a purge gas channel 348 for feeding a purge gas stream in line 318 into the reactor 150. In an exemplary embodiment, the reactor nozzle 316 may comprise a purge gas inlet 319 in communication with a purge gas line 318 for feeding a purge gas into the reactor 150. The purge gas inlet 319 may be disposed on a side of the reactor nozzle 316. In an alternate embodiment, the purge gas inlet 319 may be disposed through the securing element 333.

As shown, the purge gas channel 348 surrounds the feed distributor 202″. The purge gas channel 348 is in downstream communication with the purge gas inlet 319 and the purge gas line 318 for receiving the purge gas stream. The purge gas stream in line 318 may comprise an inert gas, such as nitrogen. The purge gas channel 348 may comprise a purge gas outlet 322 disposed in the reactor 150. When fed to the purge gas channel 348, the purge gas stream can blanket the reactor nozzle 316 at a positive pressure differential with the reactor 150 to ensure material from the reactor does not enter the reactor nozzle 316. The purge gas prevents coking that may occur in the reactor nozzle 316 if reactor material were to enter the reactor nozzle 316.

In an embodiment, the purge gas channel 348 may comprise a deflector 312 at the inner surface 153 of the reactor shell 154, such as, baffle, for deflecting the flow of the purge gas at the outlet 322 toward an opening 206″ of the feed tube 207′″ in a tip 329 of the distributor 202″. In an exemplary embodiment, the tip 329 of the distributor 202″ may be an elliptical shaped tip. The elliptical tip 329 may accommodate differential thermal growth between various components of the distributor 202″. The deflector 312 may extend circumferentially about the inner wall 318 of the purge gas channel 348 around the opening 206″ of the feed tube 207″. The width of the deflector 312 may range from about 1/10th to about ⅓rd of an inner diameter of the reactor nozzle 316. In an exemplary embodiment, a ratio of a width of the deflector 312 to the opening 206″ is in the range of about 1:1 to about 3:1.

In an aspect, the deflector 312 may be located at the purge gas outlet 322 of the purge gas channel 348. The purge gas stream coming out of the purge gas channel 348 from the purge gas outlet 322 comes into contact with the deflector 312. The deflector 312 deflects and increases the velocity of the purge gas stream towards the opening 206″ of the feed distributor into the reactor 150. The purge gas stream helps prevent any blockage of the opening 206″ of the feed distributor by removing any material deposited on and/or near the opening 206″. The deflector 312 helps to avoid accumulation of solids in the annular space and distribution of the feed exiting the opening 206″.

In the embodiment as shown in FIG. 4, a cooling channel 203″ comprises a distributor cooling channel 204″ for cooling the feed tube 207″ and an exit channel 227″ provided to transport the heated cooling fluid stream from the distributor cooling channel 204″ away from the distributor 202″. The exit channel 227″ may take the form of an annulus around the distributor cooling channel 204″ adjacent thereto.

For ease of explanation, the exit channel 227″ is in downstream communication with the distributor cooling channel 204″ as shown in FIG. 4. In an exemplary embodiment, a partitioning wall 222″ may separate the distributor cooling channel 204″ from the exit channel 227″. The partitioning wall 222″ may be an open cylinder. The distributor cooling channel 204″ is disposed adjacent to an outer wall 225″ of the feed tube 207″. The exit channel 227″ is spaced from the outer wall 225″ of the feed tube 207″ on an opposite side of the distributor cooling channel 204″. The partitioning wall 222″ may serve as an outer wall of the distributor cooling channel 204″ and the inner wall of the exit channel 227″.

In the embodiment as shown in FIG. 4, only the feed opening 206″ of the feed tube 207″ may be located inside the reactor 150. As shown, the distributor cooling channel 204″ is devoid of an opening inside the reactor 150 and does not communicate with the reactor. The distributor cooling channel 204″ at the inner end 211″ is closed and spaced inwardly from the inner surface 153 of the shell 154. So, the cooling fluid stream after heat exchange with the charge stream is not discharged into the reactor along with the cooled charge stream in this embodiment.

Although FIG. 4 shows one feed opening 206″ of the feed tube 207″, the feed tube 204″ of the feed distributor may comprise more than one feed opening for injecting the feed into the reactor 150. In an alternate embodiment, the feed tube 204″ of the feed distributor 202″ may comprise a plurality of feed openings 206″ for spraying the bio-oil feed into the reactor 150.

In an embodiment, the distributor cooling channel 204″ is closed at an outer end 205″ and is disposed on the outer wall 225″ of the feed tube 207″. At the inner end 211″, the distributor cooling channel 204″ is spaced outwardly of and isolated from the inner surface 153 of the shell 154. In an aspect, the distributor cooling channel 204″ is out of communication with the reactor 150. The distributor cooling channel 204″ may comprise a cooling channel inlet 344 of the distributor cooling channel 204″ at the outer end 205″. The cooling channel inlet 344 is in communication with the cooling fluid line 144 for receiving the cooling fluid. In an exemplary embodiment, the feed tube 207″ of the feed distributor 202″ may comprise one or more inner baffles 315, such as, orifice rings, disposed on the outer wall 225″ of the feed tube 207″. The one or more inner baffles 315 may extend circumferentially from the outer wall 225″ of the feed tube 207″ toward but spaced apart from the partitioning wall 222″ of the distributor cooling channel 204″. Alternatively, the one or more inner baffles 315 may extend axially from the outer wall 225″ of the feed tube 207″ toward the partitioning wall 222″ of the distributor cooling channel 204″. The one or more inner baffles 315 may enhance the distribution of the cooling fluid and provide a circumferential or axial distribution of the cooling fluid in the distributor cooling channel 204″. In an aspect, the feed tube 207″ may be free of internals, for example, distributors, or baffles to allow for manual or automated mechanical cleaning to remove buildup of feed degradation products or solids accumulation in the feed tube 207″. In an alternate embodiment, the feed tube 207″ may include one or more convolution elements 308, for example, expansion bellows, to accommodate differential thermal growth between various components.

In an embodiment, the exit channel 227″ may be provided surrounding the distributor cooling channel 204″ as shown in FIG. 4. In an aspect, the exit channel 227″ may partially or completely surround the distributor cooling channel 204″. The distributor cooling channel 204″ may have a closed outer end 309 and be disposed on the outer wall 222″ of the distributor cooling channel 204″. The distributor cooling channel 204″ and the exit channel 227″ may communicate at the inner end 211″ near the opening 206″ of the feed tube 204. The cooling channel 204″ is closed at the inner end 211″ to prevent any flow of the cooling fluid into the reactor 150. An inner end 306 of the partitioning wall 222″ of the distributor cooling channel 204″ is spaced outwardly a distance from a tip 329 of the distributor cooling channel to provide communication between the distributor cooling channel 204″ and the exit channel 227″. The exit channel 227″ is constrained by the outer wall 328. The outer wall 328 of the exit channel 227″ and the outer wall 222″ of the distributor cooling channel 204″ define the exit channel 227″ for the cooling fluid. The exit channel 227″ is provided to transport the heated cooling fluid stream from the distributor cooling channel 204″ away from the inner end 211″ of the distributor 202″. The tip 329 of the distributor deflects the heated cooling fluid stream coming from the distributor cooling channel 204″ to the exit channel 227″. The exit channel 227″ may take the form of an annulus around the distributor cooling channel 204″.

The cooling fluid stream in line 144 enters the distributor cooling channel 204″ from the cooling channel inlet 344. The cooling fluid stream flows through the distributor cooling channel 204″, in contact with the outer wall 225″ of the feed tube 207″ and cools the charge stream flowing through the feed tube 207″. In an exemplary embodiment, the outer wall 225″ of the feed tube 207″ may comprise dimpled surface, such as, a plurality of concavities, for enhanced heat transfer. The heated cooling fluid stream in the distributor cooling channel 204″ then bends around the inner end 306 of the partitioning wall 222″ directed by the tip 329. The heated cooling fluid stream is deflected from the tip 329 of the distributor and enters the exit channel 227″. In an embodiment, the exit channel 227″ may comprise a cooling channel outlet 342. The heated cooling fluid stream is conveyed through the exit channel 227″ and is discharged through the cooling channel outlet 342.

In an exemplary embodiment, the distributor cooling channel 204″ may comprise one or more outer baffles 314, such as, orifice rings, disposed on the outer wall 222″ of the distributor cooling channel 204″. The one or more outer baffles 314 may extend circumferentially from the outer wall 222″ of the distributor cooling channel 204″ toward but spaced apart from the outer wall 328 of the exit channel 227″. Alternatively, the one or more outer baffles 314 may extend axially from the outer wall 222″ of the distributor cooling channel 204″ toward the outer wall 328 of the exit channel 227″.

In an exemplary embodiment, the feed distributor 204″ can be a self-contained independent apparatus which is installed in the reactor nozzle 316 concentrically and held in place with a securing element 333. The feed distributor 204″ as shown in FIG. 4 allows for removal, servicing, or replacement of the distributor independent of the reactor shell 154.

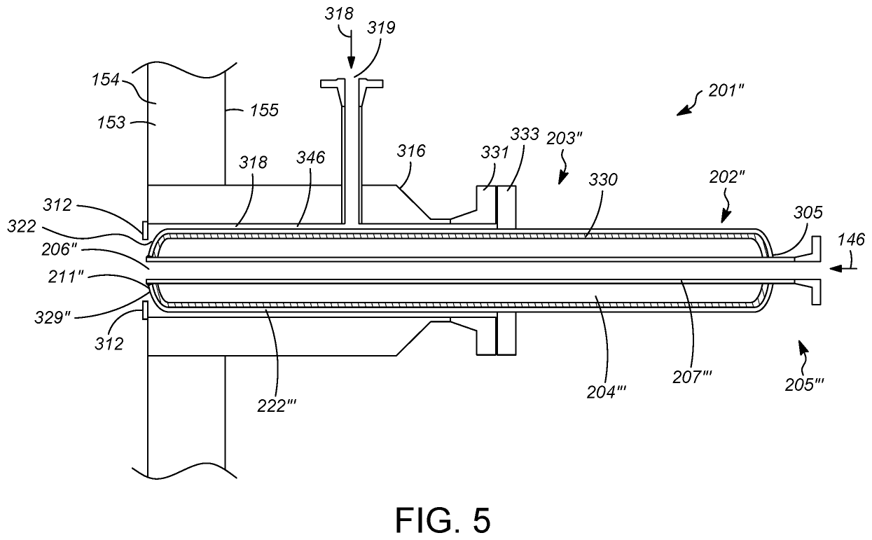

FIG. 5 shown an alternate embodiment of the feed distributor 202″′ of a distributor network 201′″ as shown in FIG. 4. Elements in FIG. 5 with the same configuration as in FIG. 4 will have the same reference numeral as in FIG. 4. Elements in FIG. 5 which have a different configuration as the corresponding element in FIG. 4 will have the same reference numeral but designated with a tripe prime symbol (″′). The configuration and operation of the embodiment of FIG. 5 is essentially the same as in FIG. 4 with the following exceptions.

In the exemplary embodiment as shown in FIG. 5, the cooling channel 203′″ may comprise a closed jacket distributor cooling channel 204″′ devoid of any inlet and outlet. The closed jacket distributor cooling channel 204″′ provides a closed channel for cooling and/or maintaining the temperature of the feed distributor 202″′ and/or the bio-oil feed in line 146. In an exemplary embodiment, the closed jacket distributor cooling channel 204″ may comprise air as a cooling fluid stream to provide an insulation and/or cooling to the feed tube 207′″. The closed jacket distributor cooling channel 204′″ with or without air may cool and/or maintain the temperature of the feed distributor and/or the bio-oil at about 95° C. or less. The closed jacket distributor cooling channel 204′″ as shown in FIG. 5 is devoid of any exit channel for the cooling fluid. In an optional embodiment, the closed jacket distributor cooling channel 204′″ may comprise a layer insulation 330, such as, refractory and/or ceramic, to maintain the bio-oil and/or the feed distributor at a temperature of about 95° C. or less.

### Examples

A 2L stirred tank reactor pilot plant was operated under several testing regimes to continuously upgrade bio-oil under hydroprocessing conditions. The bio-oil feedstock used in these tests was a thermal bio-oil derived from softwood biomass. Prior to introduction into the reactor, the bio-oil was blended in a feed tank with a molybdenum-containing catalyst precursor, such as molybdenum octoate. A sulfiding agent was added either directly to the feed tank or co-fed with the bio-oil to the reactor to maintain the catalyst in a sulfided state. A hydrogen-containing gas stream was combined with the bio-oil feed upstream of the reactor.

The combined bio-oil feed stream passed through a heat exchanger, the outlet positioned a few inches upstream of the reactor inlet. The heat exchanger was configured to cool the bio-oil feed by indirect heat exchange with a cooling fluid prior to injection into the reactor. After reaction, the reactor effluent was routed through one or more of hot separators, cold separators, or an oil-water separator to produce two upgraded oil products, a heavy upgraded bio-oil and a light upgraded bio-oil, an aqueous phase, and an off-gas stream. The heavy upgraded oil was recycled and combined with the feed upstream of the reactor.

The reactor was operated at temperatures of approximately 700° F. and pressures of approximately 1300 psig with a bio-oil feed rate of 300 g/hr and a recycle oil flow rate of 50 g/hr. The cooling heat exchanger upstream of the reactor was operated to cool the bio-oil from the hot metal of the reactor. Representative operating conditions for selected experiments are summarized in Table 1 below.

TABLE 1

| | | | | Heat |
|---|---|---|---|---|
| | Reactor | | Bio-oil | Exchanger |
| | Temperature | Pressure | Flow Rate | Temperature |
| Exp. | (° F.) | (psig) | (g/hr) | (° F.) |
| A1 | 722 | 1299 | 300 | 68.3 |
| A2 | 721 | 1301 | 300 | 68.1 |
| A3 | 721 | 1301 | 300 | 68.0 |
| B | 689 | 1299 | 300 | 80.5 |

During operation, the average inlet temperature of the bio-oil entering the reactor was monitored, as was the pressure exerted by the bio-oil feed pump. When there was a restriction building in the reactor inlet, the required pressure from the pump increased. Additionally, the pump pressure was also monitored across time, so a rate of pressure change was calculated across the feed system during steady-state operation. As used herein, the rate of pressure change is expressed as a change in pressure over time (delta psi/hr) and provides an indication of feed system stability, fouling, or restriction development at or near the reactor inlet.

Table 2 below summarizes the observed relationship between the average inlet temperature of the bio-oil and the corresponding rate of pressure change for the experiments described above.

TABLE 2

| | | | Rate of |
|---|---|---|---|
| | Average | Average | Pressure |
| | Inlet | Inlet | Change |
| | Temperature | Temperature | (delta |
| Exp. | (° F.) | (° C.) | psi/hr) |
| A1 | 204 | 95.5 | 0.7 |
| A2 | 209 | 98.3 | 2.3 |
| A3 | 210 | 98.8 | 2.6 |
| B | 199 | 92.8 | <0.1 |

As shown in Table 2, experiments conducted at higher average inlet temperatures exhibited significantly higher rates of pressure increase. For example, experiments A2 and A3, with average inlet temperatures of approximately 209-210° F., experienced pressure increase rates greater than 2 psi/hr, whereas experiment B, conducted at an average inlet temperature of approximately 199° F., exhibited a negligible pressure increase (shown as rate of less than 0.1 psi/hr). These results demonstrate that maintaining a lower bio-oil inlet temperature substantially reduces the rate of pressure increase in the feed system.

FIG. 6 shows a plot depicting the bio-oil feed pump pressure in a solid line and depicting the inlet temperature of the bio-oil entering the reactor in a dashed line for the Experiments A1-A3. Similar plot is provided for Experiment B as shown in FIG. 7. In FIG. 7, a plot is shown depicting the bio-oil feed pump pressure in a solid line and depicting the inlet temperature of the bio-oil entering the reactor in a dashed line for the Experiment B. As shown in FIGS. 6 and 7, increases in inlet temperature correspond closely with increases in feed pump discharge pressure over time, indicating progressive restriction or fouling. Conversely, when the inlet temperature is reduced by cooling the feed distributor, the pump discharge pressure remains substantially stable. Each snapshot of data as shown in FIGS. 6 and 7 is approximately three days long, indicating the stability of the process.

These results demonstrate that cooling the bio-oil feed stream at or immediately upstream of the reactor inlet, such as by cooling a feed distributor with a cooling fluid stream, reduces pressure instability and mitigates fouling or plugging in the feed system. The data supports the use of a cooled feed distributor to enable stable, continuous operation of a bio-oil upgrading reactor at elevated temperature and pressure.

### Specific Embodiments

While the following is described in conjunction with specific embodiments, it will be understood that this description is intended to illustrate and not limit the scope of the preceding description and the appended claims.

A first embodiment of the present disclosure is a process for upgrading a pyrolysis oil stream, comprising charging a bio-oil stream at a temperature of about 95° C. or less through a feed distributor into a reactor, wherein the feed distributor is cooled with a cooling fluid stream; passing a hydrogen stream to the reactor; and reacting the bio-oil stream with the hydrogen stream in the presence of a catalyst in the reactor to produce an upgraded bio-oil stream. An embodiment of the present disclosure is one, any or all of prior embodiments in this paragraph up through the first embodiment in this paragraph, wherein the bio-oil stream is at a temperature of about 80° C. or less. An embodiment of the present disclosure is one, any or all of prior embodiments in this paragraph up through the first embodiment in this paragraph, wherein the hydrogen stream serves as the cooling fluid stream and is passed into the reactor with the bio-oil stream through the feed distributor. An embodiment of the present disclosure is one, any or all of prior embodiments in this paragraph up through the first embodiment in this paragraph, wherein the bio-oil stream is cooled as it passes from a feed line through a shell of the reactor and travels toward an opening in the distributor to the reactor. An embodiment of the present disclosure is one, any or all of prior embodiments in this paragraph up through the first embodiment in this paragraph, wherein the feed distributor comprises a second opening for discharging the hydrogen stream into the reactor. An embodiment of the present disclosure is one, any or all of prior embodiments in this paragraph up through the first embodiment in this paragraph, wherein the feed distributor comprises a tube in downstream communication with the feed line for transporting the bio-oil into the reactor and a channel for passing the cooling fluid to exchange heat with the pyrolysis oil. An embodiment of the present disclosure is one, any or all of prior embodiments in this paragraph up through the first embodiment in this paragraph, wherein the tube and the channel share a wall through which heat is exchanged. An embodiment of the present disclosure is one, any or all of prior embodiments in this paragraph up through the first embodiment in this paragraph further comprising mixing the bio-oil stream with a catalyst stream to provide a charge stream; cooling and maintaining the temperature of the charge stream at about 95° C. or less; and charging a cooled charge stream through a feed distributor into the reactor through an opening in the feed distributor. An embodiment of the present disclosure is one, any or all of prior embodiments in this paragraph up through the first embodiment in this paragraph, wherein the reactor is at a temperature of about 300° C. to about 500° C. An embodiment of the present disclosure is one, any or all of prior embodiments in this paragraph up through the first embodiment in this paragraph further comprising taking a recycle stream from the upgraded bio-oil stream; and charging the recycle oil stream into the reactor. An embodiment of the present disclosure is one, any or all of prior embodiments in this paragraph up through the first embodiment in this paragraph further comprising passing the recycle oil stream into the reactor through the feed distributor. An embodiment of the present disclosure is one, any or all of prior embodiments in this paragraph up through the first embodiment in this paragraph, wherein the bio-oil stream is charged near a bottom of the reactor. An embodiment of the present disclosure is one, any or all of prior embodiments in this paragraph up through the first embodiment in this paragraph further comprising feeding a purge gas from a purge gas channel surrounding the feed distributor into the reactor. An embodiment of the present disclosure is one, any or all of prior embodiments in this paragraph up through the first embodiment in this paragraph, wherein the cooling fluid stream comprises a recycle gas, liquid petroleum gas, or a combination thereof.

A second embodiment of the present disclosure is a process for upgrading a bio-oil stream, comprising charging a bio-oil stream at a temperature of about 95° C. or less through a feed distributor into a reactor, wherein the feed distributor is cooled with a cooling fluid stream as the bio-oil stream passe s through a shell of the reactor and through an opening of the distributor into the reactor; passing a hydrogen stream to the reactor; and reacting the bio-oil stream with the hydrogen stream in the presence of a catalyst in the reactor to produce an upgraded bio-oil stream. An embodiment of the present disclosure is one, any or all of prior embodiments in this paragraph up through the second embodiment in this paragraph, wherein the hydrogen stream serves as the cooling fluid stream and is passed into the reactor through an opening.

A third embodiment of the present disclosure is an apparatus for upgrading a bio-oil stream, comprising a reactor comprising a shell; a feed distributor comprising an outer end disposed outside of the reactor and an opening disposed in the reactor; a feed manifold extending from the outer end to the opening of the feed distributor and in communication with a feed line; a cooling channel adjacent to the feed distributor extending through the shell to the opening of the feed distributor for maintaining the temperature of the feed distributor with a cooling fluid stream; and a product outlet in the shell. An embodiment of the present disclosure is one, any or all of prior embodiments in this paragraph up through the third embodiment in this paragraph, wherein the cooling channel has an opening in the reactor adjacent to the opening of the feed distributor. An embodiment of the present disclosure is one, any or all of prior embodiments in this paragraph up through the third embodiment in this paragraph, wherein a plurality of feed distributors are supplied by the feed manifold and the cooling channel comprises a cooling manifold that surrounds the feed manifold and the feed distributors. An embodiment of the present disclosure is one, any or all of prior embodiments in this paragraph up through the third embodiment in this paragraph, wherein the opening of the distributor is disposed in a bottom half of the reactor. An embodiment of the present disclosure is one, any or all of prior embodiments in this paragraph up through the third embodiment in this paragraph, wherein the feed distributor comprises a feed tube and the cooling channel surrounds a wall of the feed tube. An embodiment of the present disclosure is one, any or all of prior embodiments in this paragraph up through the third embodiment in this paragraph, further including an exit channel adjacent to a wall of the cooling channel. An embodiment of the present disclosure is one, any or all of prior embodiments in this paragraph up through the third embodiment in this paragraph, further comprising a purge gas channel surrounding the cooling channel, the purge gas channel comprising an inlet in communication with a purge gas line and an outlet disposed in the reactor in communication with the opening of the feed distributor. An embodiment of the present disclosure is one, any or all of prior embodiments in this paragraph up through the third embodiment in this paragraph, wherein the purge gas channel comprises a deflector at the outlet, the deflector extending circumferentially from an inner wall of the purge gas channel towards the opening of the feed distributor. An embodiment of the present disclosure is one, any or all of prior embodiments in this paragraph up through the third embodiment in this paragraph, wherein a ratio of a width of the deflector to the opening of the feed distributor is in the range of about 1:3 to about 1:1. An embodiment of the present disclosure is one, any or all of prior embodiments in this paragraph up through the third embodiment in this paragraph, wherein the purge gas channel is located inside a nozzle of the reactor configured for inserting the feed distributor into the reactor. An embodiment of the present disclosure is one, any or all of prior embodiments in this paragraph up through the third embodiment in this paragraph, wherein the feed distributor comprises an orifice ring disposed on an outer wall of the feed distributor, the orifice ring extending from the outer wall of the feed distributor toward a wall of the cooling channel. An embodiment of the present disclosure is one, any or all of prior embodiments in this paragraph up through the third embodiment in this paragraph, wherein the cooling channel comprises an orifice ring disposed on an outer wall of the cooling channel, the orifice ring extending from the outer wall of the cooling channel to a wall of the exit channel. An embodiment of the present disclosure is one, any or all of prior embodiments in this paragraph up through the third embodiment in this paragraph, wherein the feed distributor comprises a plurality of openings. An embodiment of the present disclosure is one, any or all of prior embodiments in this paragraph up through the third embodiment in this paragraph, wherein the openings of the feed distributor are arranged in an elliptical pattern. An embodiment of the present disclosure is one, any or all of prior embodiments in this paragraph up through the third embodiment in this paragraph, wherein an outer wall of the feed distributor comprises a plurality of dimples. An embodiment of the present disclosure is one, any or all of prior embodiments in this paragraph up through the third embodiment in this paragraph, wherein the cooling channel is a closed channel comprising an insulation material for maintaining the temperature of the feed distributor.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for upgrading a bio-oil stream, comprising:
charging a bio-oil stream at a temperature of about 95° C. or less through a feed distributor into a reactor, wherein the feed distributor is cooled with a cooling fluid stream;
passing a hydrogen stream to the reactor; and
reacting said bio-oil stream with said hydrogen stream in the presence of a catalyst in the reactor to produce an upgraded bio-oil stream.

2. The process of claim 1, wherein the bio-oil stream is at a temperature of about 80° C. or less.

3. The process of claim 1, wherein said hydrogen stream serves as the cooling fluid stream.

4. The process of claim 1, wherein said bio-oil stream is cooled as it passes from a feed line through a shell of the reactor and travels toward an opening in the distributor to the reactor.

5. The process of claim 3, wherein said feed distributor comprises a second opening for discharging said hydrogen stream into the reactor.

6. The process of claim 4, wherein said feed distributor comprises a tube in downstream communication with the feed line for transporting said bio-oil into the reactor and a channel for passing the cooling fluid to exchange heat with the bio-oil.

7. The process of claim 6, wherein said tube and said channel share a wall through which heat is exchanged.

8. The process of claim 1 further comprising:
mixing said bio-oil stream with a catalyst stream to provide a charge stream;
cooling and maintaining the temperature of said charge stream at about 95° C. or less; and
charging a cooled charge stream through a feed distributor into the reactor through an opening in the feed distributor.

9. The process of claim 1 further comprising feeding a purge gas from a purge gas channel surrounding said feed distributor into the reactor.

10. The process of claim 1, wherein said cooling fluid stream comprises a recycle gas, liquid petroleum gas, or a combination thereof.

11. A process for upgrading a bio-oil stream, comprising:
charging a bio-oil stream at a temperature of about 95° C. or less through a feed distributor into a reactor, wherein the feed distributor is cooled with a cooling fluid stream as said bio-oil stream passes through a shell of the reactor and through an opening in the distributor into the reactor;
passing a hydrogen stream to the reactor; and
reacting said bio-oil stream with said hydrogen stream in the presence of a catalyst in the reactor to produce an upgraded bio-oil stream.

12. An apparatus for upgrading a bio-oil stream, comprising:
a reactor comprising a shell;
a feed distributor comprising an outer end disposed outside of the reactor and an opening disposed in the reactor;
a feed manifold extending from the outer end of the feed distributor and in communication with a feed line;
a cooling channel adjacent to said feed distributor extending through the shell to the opening of the feed distributor for maintaining the temperature of the feed distributor with a cooling fluid stream; and
a product outlet in the shell.

13. The apparatus of claim 12, wherein a plurality of feed distributors are supplied by the feed manifold and the cooling channel comprises a cooling manifold that surrounds the feed manifold.

14. The apparatus of claim 13, wherein the feed distributor comprises a feed tube and the cooling channel surrounds a wall of the feed tube.

15. The apparatus of claim 14, further including an exit channel adjacent to a wall of the cooling channel.

16. The apparatus of claim 13 further comprising a purge gas channel surrounding said cooling channel, the purge gas channel comprising an inlet in communication with a purge gas line and an outlet disposed in the reactor in communication with the opening of said feed distributor.

17. The apparatus of claim 16, wherein said purge gas channel comprises a deflector at the outlet, said deflector extending circumferentially from an inner wall of said purge gas channel towards the opening of said feed distributor.

18. The apparatus of claim 17, wherein said purge gas channel is located inside a nozzle of the reactor configured for inserting said feed distributor into the reactor.

19. The apparatus of claim 13, wherein said feed distributor comprises an orifice ring disposed on an outer wall of said feed distributor and/or said cooling channel.

20. The apparatus of claim 13, wherein said feed distributor comprises an elliptical shaped tip.

21. The apparatus of claim 13, wherein an outer wall of said feed distributor comprises a plurality of dimples.

22. The apparatus of claim 13, wherein said cooling channel is a closed channel comprising an insulation material for maintaining the temperature of the feed distributor.
